(19) United States
(12) Patent Application Publication
(10) Pub. No.: US 2012/0052861 A1
(43) Pub. Date: Mar. 1, 2012

(54) Method and Apparatus for Automatically Initiating a Second Mobile Communication to Avoid and Reduce Costs

(75) Inventor: Silke Holtmanns, Klaukkala (FI)

(73) Assignee: NOKIA CORPORATION, Espoo (FI)

(21) Appl. No.: 12/868,518

(22) Filed: Aug. 25, 2010

(51) Int. Cl. H04W 4/00

(52) U.S. Cl. 455/432.1

(57) ABSTRACT

In accordance with an example embodiment of the present invention, an apparatus comprises at least one processor and at least one memory including computer program code. The at least one memory and the computer program code configured to, with the at least one processor, cause the apparatus to perform at least the following initiate a first mobile communication using a called number associated with a non-local subscriber identity information, the non-local subscriber identity information associated with a second apparatus, and automatically initiate a second mobile communication using a local subscriber identity contact information associated with the called number in such a manner as to avoid using a roaming area.

### TECHNICAL FIELD

The present application relates generally to a method and apparatus for automatically initiating a second mobile communication to avoid and reduce costs.

### BACKGROUND

An electronic device may have a facilitate communication. As such, the electronic device allows a user to communication in any number of locations using the services of different communication network providers.

### SUMMARY

Various aspects of the invention are set out in the claims.

In accordance with an example embodiment of the present invention, the apparatus comprises at least one processor and at least one memory including computer program code. The at least one memory and the computer program code configured to, with the at least one processor, cause the apparatus to perform at least the following initiate a first mobile communication using a called number associated with a non-local subscriber identity information, the non-local subscriber identity information associated with a second mobile communication automatically initiate a second mobile communication using a local subscriber identity contact information associated with the called number in such a manner as to avoid using a roaming area.

In accordance with another example embodiment of the present invention, a method comprises initiating a first mobile communication using a called number associated with a non-local subscriber identity contact information of a device and automatically initiating a second mobile communication using the local subscriber identity contact information of the device in such a manner as to avoid using a roaming area, the a non-local subscriber identity and local subscriber identity associated with the same device.

In accordance with another example embodiment of the present invention, the apparatus comprises at least one processor and at least one memory including computer program code. The at least one memory and the computer program code configured to, with the at least one processor, cause the apparatus to perform at least the following receive a first mobile communication related to a non-local subscriber identity information of the apparatus and automatically begin a second mobile communication using the local subscriber identity contact information of the apparatus in such a manner as to avoid using a roaming area, the a non-local subscriber identity and local subscriber identity associated with the same device.

In accordance with another example embodiment of the present invention, a method comprises receiving a first mobile communication related to a non-local subscriber identity information of an apparatus and automatically receiving a second mobile communication using the local subscriber identity contact information of the apparatus in such a manner as to avoid using a roaming area.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting an electronic device and a second electronic device 210 operating in accordance with an example embodiment of the invention;

FIG. 3 is a flow diagram depicting an example method for automatically initiating a second mobile communication from a first electronic device in accordance with an example embodiment of the invention;

FIG. 4 is a block diagram depicting an electronic device and another electronic device operating in accordance with an example embodiment of the invention; and

FIG. 5 is a flow diagram depicting an example method for automatically initiating a second mobile communication from a second electronic device in accordance with an example embodiment of the invention.

### DETAILED DESCRIPTION OF THE DRAWINGS

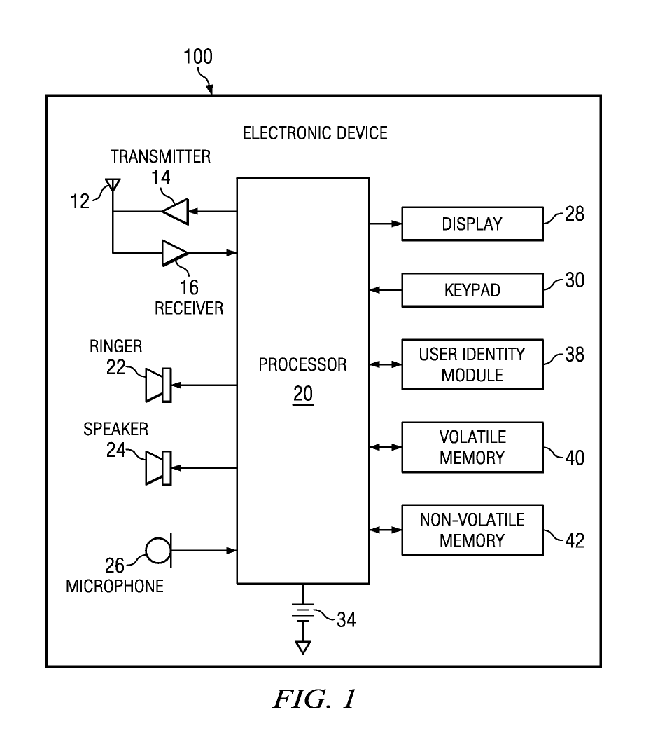

An example embodiment of the present invention and its potential advantages are best understood by referring to FIGS. 1 through 5 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, the one or more output devices of the user interface may be coupled to the processor 20.

In an example embodiment, the user interface allows the electronic device 100 to receive or transmit data. For example, the user interface may comprise any of a number of devices configured to receive data, such as a keypad 30, a touch display, other input device, and/or the like. In an embodiment, the keypad 30 may comprise the conventional numeric, e.g., 0-9, and/or related keys, e.g., #, *, other hard and/or soft keys, and/or the like to operate the electronic device 100. In an alternative embodiment, the keypad 30 may comprise a conventional QWERTY keypad arrangement. Further, the keypad 30 may also comprise various soft keys with associated features. If desired, the electronic device 100 may comprise a user interface device, such as a joystick or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprise signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

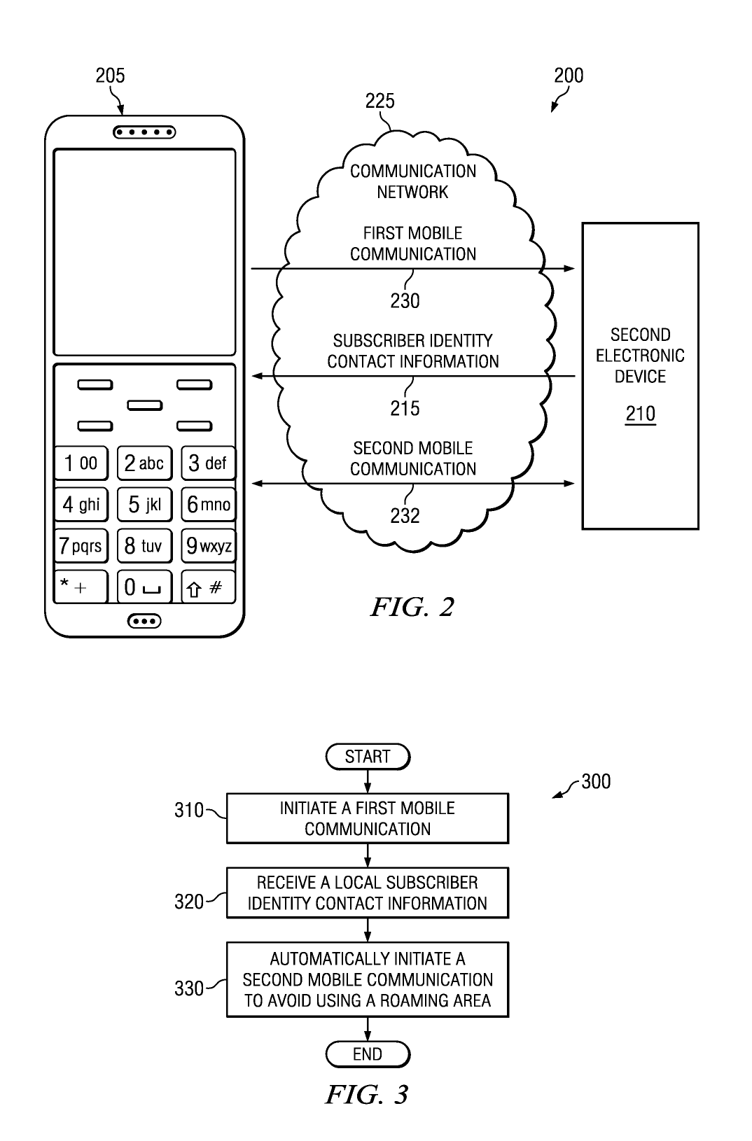

FIG. 2 is a block diagram 200 depicting an electronic device 205 and a second electronic device 210 operating in accordance with an example embodiment of the invention. In an embodiment, the electronic device 205 may comprise a processor, such as processor 20 of FIG. 1. In an embodiment, the second electronic device 210 may comprise a processor 240 and/or the like. The electronic device 205 and the second electronic device 210 may comprise memory and/or computer code, such as electronic device 100 of FIG. 1.

In an example embodiment, the electronic device 205 and the second electronic device 210 are in communication, via a communication network 225. In an example embodiment, electronic device 205, e.g., an apparatus comprises at least one processor and at least one memory including computer program code. The at least one memory and the computer program code configured to, with the at least one processor, cause the electronic device 205 to perform at least the following initiate a first mobile communication 230 using a called number associated with a non-local subscriber identity information and automatically initiate a second mobile communication 232 using a local subscriber identity contact information 215 associated with the called number in such a manner as to avoid using a roaming area, the a non-local subscriber identity and local subscriber identity associated with the same apparatus. In an example embodiment, the first communication 230 and second mobile communication 232 is at least one of a video call, mobile call, other suitable communication, and/or the like. In an example embodiment, the at least one memory and the computer program code configured to, with the at least one processor, further causes the electronic device 205 to cancel the first mobile communication 230.

Consider the following example. The electronic device 205 initiates a mobile call, e.g., the first mobile communication 230, to the second electronic device 210. The second electronic device 210 has a number, e.g., the called number, associated with a non-local subscriber identity information. That is, the second electronic device 210 is roaming. In an embodiment, the second electronic device 210 transmits local subscriber identity contact information. The local subscriber identity contact information is transmitted via at least one of a short message service, an email, multimedia messaging service, open mobile alliance push message, and a suitable communication. In an example embodiment, at least one memory and the computer program code configured to, with the at least one processor, further causes the apparatus to receive the local subscriber identity contact information 215 from a second apparatus, e.g., the second electronic device 210.

In an example embodiment, the received local subscriber identity contact information 215 is received via at least one of a short message service, an email, multimedia messaging service, open mobile alliance push message, other suitable communication, and/or the like. In such a case, the electronic device 205 automatically initiate a second call, e.g., a second mobile communication 232, using a local subscriber identity contact information 215 associated with the called number in such a manner as to avoid using a roaming area. One technical effect is automatically initiating a second mobile communication by a transmitting electronic device to avoid roaming costs where a second electronic device is roaming.

In an alternative embodiment, automatically initiating a second mobile communication 232 accepts the second mobile communication 230 from the second electronic device 210. That is, the second electronic device 210 automatically initiates the second mobile communication 232 based at least in part on the roaming. It should be understood that in an example embodiment, the local subscriber identity contact 215 is at least one of the following: a subscriber identity module, a universal integrated circuit card, other suitable subscriber identity contact, and/or the like.

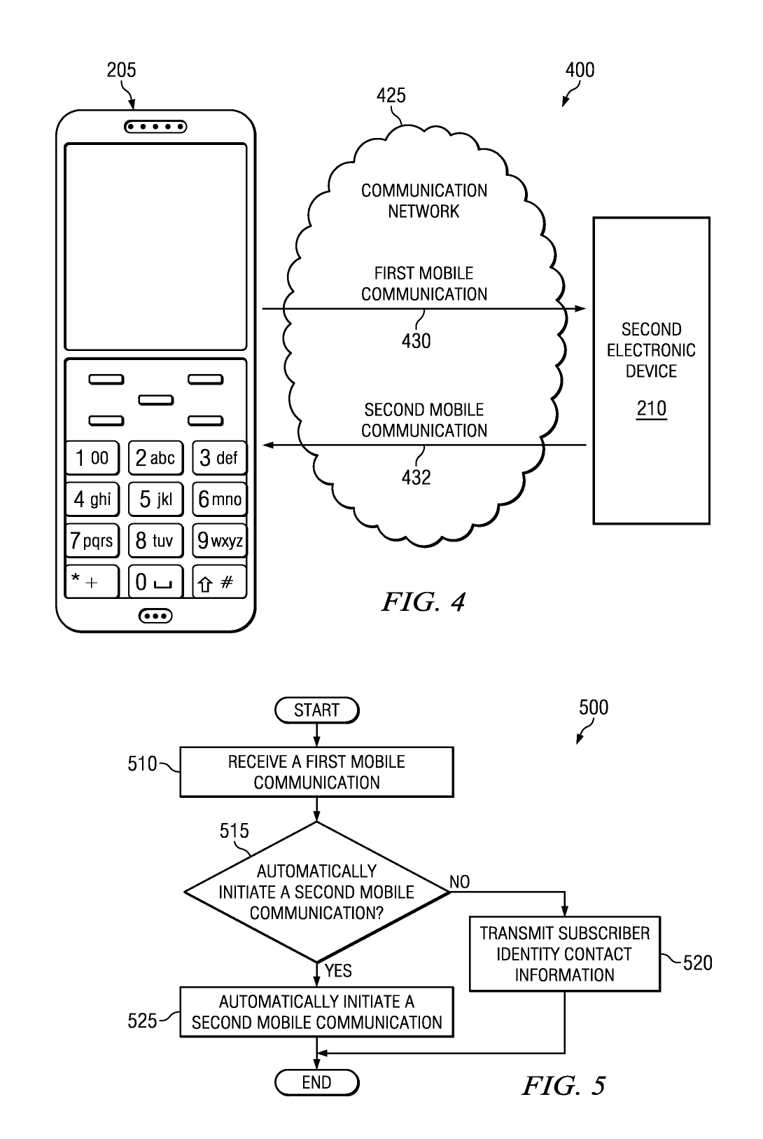

FIG. 3 is a flow diagram depicting an example method 300 for automatically initiating a second mobile communication from a first electronic device in accordance with an example embodiment of the invention. Example method 300 may be performed by an electronic device, such as electronic device 205 of FIG. 2 and/or FIG. 4.

At 310, a first mobile communication is initiated. In an example embodiment, the first electronic device initiates a first mobile communication using a called number associated with a non-local subscriber identity information. For example, the first electronic device calls a second electronic device, which is roaming.

At 320, local subscriber identity contact information is received. In an example embodiment, the first electronic device receives local subscriber identity contact information, such as local subscriber identity contact information 215 of FIG. 2, from a second electronic device, such as second electronic device 210 of FIG. 2. For example, the first electronic device receives a new contact number, which is local to the second electronic device.

At 330, a second mobile communication to avoid using a roaming area is automatically initiated. In an example embodiment, the first electronic device automatically initiates a second mobile communication using the local subscriber identity contact information associated with the called number in such a manner as to avoid using a roaming area. For example, the first electronic device calls the second electronic device using the received contact number, which is local to the second electronic device. The example method 300 ends.

FIG. 4 is a block diagram 400 depicting an electronic device and another electronic device operating in accordance with an example embodiment of the invention. In an embodiment, the electronic device 205 may comprise a processor, such as processor 20 of FIG. 1. In an embodiment, the second electronic device 210 may comprise a processor 240 and/or the like. The electronic device 205 and the second electronic device 210 may comprise memory and/or computer code, such as electronic device 100 of FIG. 1.

In an example embodiment, the electronic device 205 and the second electronic device 210 are in communication, via a communication network 425. In an example embodiment, the second electronic device 210, e.g., an apparatus comprises at least one processor and at least one memory including computer program code. The at least one memory and the computer program code configured to, with the at least one processor, cause the electronic device 210 to perform at least the following receive a first mobile communication 430 related to a non-local subscriber identity information of the electronic device 210 and automatically begin a second mobile communication 432 using the local subscriber identity contact information of the second electronic device 210 in such a manner as to avoid using a roaming area. In an example embodiment, the first communication 230 and second mobile communication 232 is at least one of a video call, mobile call, other suitable communication, and/or the like.

Consider the following example. The electronic device 205 initiates a mobile call, e.g., the first mobile communication 230, with the second electronic device 210. The second electronic device 210 has a number, e.g., the called number, associated with a non-local subscriber identity information. That is, the second electronic device 210 is roaming. In an example embodiment, the at least one memory and the computer program code configured to, with the at least one processor, further causes the second electronic device 210 to perform transmit a local subscriber identity contact information of the second electronic device 210 associated with the non-local subscriber identity information.

In an example embodiment, at least one memory and the computer program code configured to, with the at least one processor, further causes the electronic device 205 to receive the local subscriber identity contact information 215 from a second apparatus, e.g., the second electronic device 210. In an example embodiment, the second mobile communication 432 is an outgoing mobile communication to the electronic device 205 based at least in part on the local subscriber identity contact information of the second electronic device 210. Restated, the second electronic device 210 automatically begins a second mobile communication 432 using the local subscriber identity contact information in such a manner as to avoid using a roaming area. That is, the second electronic device 210 calls the first electronic device 205 with a non-roaming contact. A possible technical effect of one or more of the example embodiments disclosed herein is automatically initiating a second mobile communication by a second electronic device 210 to avoid roaming costs where a second electronic device is roaming.

FIG. 5 is a flow diagram depicting an example method 500 for automatically initiating a second mobile communication from a second electronic device in accordance with an example embodiment of the invention. Example method 500 may be performed by an electronic device, such as electronic device 210 of FIG. 2 and/or FIG. 4.

At 510, a first mobile communication is received. In an example embodiment, the electronic device receives a first mobile communication 430 related to a non-local subscriber identity information. For example, a second electronic device, such as electronic device 205 of FIG. 2 and/or FIG. 4, calls the electronic device.

At 515, it is determined if a second mobile communication is to be automatically initiated. In an example embodiment, an apparatus is configured to determine whether the second mobile communication is to be automatically initiated. In an embodiment, the apparatus may receive a SMS with a specific information embedded indicating the automatic initiation. If the apparatus supports such information, then the mobile communications set up automatically. Alternatively, the apparatus may display the SMS and allow a user to go into the SMS and click a presented “alternative contact number.”

If at 515, it is determined to automatically initiate a second mobile communication, than at 525 a second mobile communication is automatically initiated. In an example embodiment, the second electronic device automatically initiates a second mobile communication, such as second mobile communication 232 of FIG. 2. That is, the electronic device automatically calls the second electronic device based, for example, at least in part on the roaming. The example method 500 ends.

If at 515, it is determined not to automatically initiate a second mobile communication, than at 520 subscriber identity contact information is transmitted. In an example embodiment, the at least one memory and the computer program code configured to, with the at least one processor, further causes the electronic device to perform transmit a local subscriber identity contact information of the electronic device associated with the non-local subscriber identity information. For example, the electronic device sends the second electronic device a call back number. The example method 500 ends.

Without in any way limiting the scope, interpretation, or application of the claims appearing below, it is possible that a technical effect of one or more of the example embodiments disclosed herein may be automatically initiating a second mobile communication from a receiving electronic device to avoid roaming costs. Another possible technical effect of one or more of the example embodiments disclosed herein may be automatically initiating a second mobile communication by a second electronic device to avoid roaming costs where a second electronic device is roaming.

Embodiments of the present invention may be implemented in software, hardware, application logic or a combination of software, hardware and application logic. The software, application logic and/or hardware may reside on an electronic device, a computer, or a service. If desired, part of the software, application logic and/or hardware may reside on an electronic device, part of the software, application logic and/or hardware may reside on a computer, and part of the software, application logic and/or hardware may reside on a service. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2 and/or FIG. 4. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
at least one processor; and
at least one memory including computer program code
the at least one memory and the computer program code configured to, with the at least one processor, cause the apparatus to perform at least one of the following:
initiate a first mobile communication using a called number associated with a non-local subscriber identity information, the non-local subscriber identity information associated with a second apparatus; and
automatically initiate a second mobile communication using a local subscriber identity contact information associated with the called number in such a manner as to avoid using a roaming area.

2. The apparatus of claim 1 the at least one memory and the computer program code configured to, with the at least one processor, further causes the apparatus to receive the local subscriber identity contact information from the second apparatus.

3. The apparatus of claim 2 wherein the received a local subscriber identity contact information is received via at least one of a short message service, an email, multimedia messaging service, open mobile alliance push message and a suitable communication.

4. The apparatus of claim 1 wherein automatically initiate a second mobile communication accepts the second mobile communication from the second apparatus.

5. The apparatus of claim 1 wherein the first communication and second mobile communication is at least one of a video call, mobile call, and other suitable communication.

6. The apparatus of claim 1 the at least one memory and the computer program code configured to, with the at least one processor, further causes the apparatus to cancel the first mobile communication.

7. A method, comprising:
initiating a first mobile communication using a called number associated with a non-local subscriber identity contact information of a device; and
automatically initiating a second mobile communication using the local subscriber identity contact information of the device in such a manner as to avoid using a roaming area, the a non-local subscriber identity and local subscriber identity associated with the same device.

8. The method of claim 7 further comprising receiving local subscriber identity contact information associated with the called number associated with the non-local subscriber identity contact information of the device.

9. The method of claim 8 wherein receiving a local subscriber identity contact information further comprising receiving the local subscriber identity contact information via at least one of a short message service, an email, multimedia messaging service, open mobile alliance push message, and a suitable communication.

10. The method of claim 7 wherein automatically initiate a second mobile communication further comprises accepting the second mobile communication from a second apparatus.

11. The method of claim 7 wherein the first communication and second mobile communication is at least one of a video call, mobile call, and other suitable communication.

12. The method of claim 7 further comprises cancelling the first mobile communication.

13. An apparatus, comprising:
at least one processor; and
at least one memory including computer program code
the at least one memory and the computer program code configured to, with the at least one processor, cause the apparatus to perform at least one of the following:
receive a first mobile communication related to a non-local subscriber identity information of the apparatus; and
automatically begin a second mobile communication using the local subscriber identity contact information of the apparatus in such a manner as to avoid using a roaming area, the a non-local subscriber identity and local subscriber identity associated with the same apparatus.

14. The apparatus of claim 13 wherein the at least one memory and the computer program code configured to, with the at least one processor, further causes the apparatus to perform transmit a local subscriber identity contact information of the apparatus associated with the non-local subscriber identity information.

15. The apparatus of claim 14 wherein the transmitted local subscriber identity contact information is transmitted via at least one of a short message service, an email, multimedia messaging service, open mobile alliance push message, and a suitable communication.

16. The apparatus of claim 13 wherein the second mobile communication is an outgoing mobile communication to a second apparatus based at least in part on the local subscriber identity contact information of the apparatus.

17. The apparatus of claim 13 wherein the first communication and second mobile communication is at least one of a video call, mobile call, data call and other suitable communication.

18. A method, comprising:
receiving a first mobile communication related to a non-local subscriber identity information of an apparatus; and
automatically receiving a second mobile communication using the local subscriber identity contact information of the apparatus in such a manner as to avoid using a roaming area.

19. The method of claim 18 further comprising transmitting a local subscriber identity contact information of the apparatus associated with the non-local subscriber identity information.

20. The method of claim 19 wherein transmitting a local subscriber identity contact information further comprises transmitting via at least one of a short message service, an email, multimedia messaging service, open mobile alliance push message and a suitable communication.

21. The method of claim 18 wherein the second mobile communication is an outgoing mobile communication to an apparatus based at least in part on the local subscriber identity contact information.
